(19) United States
(12) Patent Application Publication
(10) Pub. No.: US 2026/0161498 A1
(43) Pub. Date: Jun. 11, 2026

(54) AUTOMATED ANALYSIS AND PROBLEM RESOLUTION FOR ELECTRONIC DOCUMENTS

(71) Applicant: SAP SE, Walldorf (DE)

(72) Inventors: Oliver Frendo, Heidelberg (DE); Uwe Kunath, Boehlen (DE); Guoyang Weng, Mannheim (DE); Simon Tacke, Wiesloch (DE); Venkata Sudhakar Pagidi, Walldorf (DE); Ahamefule Ebogu, Offenburg (DE); Jan-Klaas Heinsohn, Walldorf (DE); Martin Berner, Koenigsbach-Stein (DE)

(21) Appl. No.: 18/976,919

(22) Filed: Dec. 11, 2024

(51) Int. Cl. G06F 11/07

(52) U.S. Cl. CPC G06F 11/0793

(57) ABSTRACT

In some embodiments, there is provided a method including in response to the indication of the error, receiving a request to resolve the error; generating a first prompt for a machine learning model; receiving, in response to the first prompt, a first prompt response; in response to receiving a first prompt response, generating a first query for augmentation information, the first query generated based on the first prompt response; executing the first query; receiving, in response to the first query, a first query response; in response to receiving the first query response to the first query, providing the first query response to the prompt builder to build a second prompt for the machine learning model. The process of prompting the second ML model, receiving a prompt response, and using the prompt response to generate a query may repeat until the error is resolved or no queries are available.

### TECHNICAL FIELD

The present disclosure generally relates to machine learning.

### BACKGROUND

Document processing may involve dozens if not hundreds of different formats. These formats may include customized formats, which may be extensions of other formats including standardized formats. Handling the different formats and their changes is important as the exchange of improperly formatted documents may prevent two systems from properly exchanging information.

### SUMMARY

Systems, methods, and articles of manufacture, including computer program products, are provided for automated analysis and resolution for electronic documents. In some embodiments, there is provided a computer-implemented method including receiving an indication of an error in document processing of an electronic document; in response to the indication of the error, receiving a request to resolve the error; generating, by a prompt builder, a first prompt for a machine learning model; sending the first prompt to the machine learning model; receiving, in response to the first prompt, a first prompt response; in response to receiving a first prompt response, generating a first query for augmentation information, the first query generated based on the first prompt response; executing the first query; receiving, in response to the first query, a first query response; in response to receiving the first query response to the first query, providing the first query response to the prompt builder to build a second prompt for the machine learning model; and in response to the second prompt response indicating end of question, sending the prompt response as an answer to resolve the error in the document processing.

In some variations, one or more features disclosed herein including the following features can optionally be included in any feasible combination.

The prompt builder may build the second prompt by combining the first prompt response, the first query, and the first query response. In response to the second prompt response not indicating the end of question, the second prompt response may be sent to a query builder to generate a second query based on the second prompt response and executing the second query. In response to the second query, a second query response may be received and in response to receiving the second query response to the first query, the second query response may be provided to the prompt builder to build a third prompt for the machine learning model. The prompt builder may build the third prompt by combining the second prompt response, the second query, and the second query response. In response to the third prompt response indicating end of question, the third prompt response may be sent as the answer to resolve the error in the document processing and in response to the third prompt response not indicating the end of question, the third prompt response may be sent to the query builder to generate a fourth query based on the third prompt response.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system for automatic problem resolution for electronic documents, according to some implementations of the current subject matter;

FIG. 2 depicts an example of a process for automatic problem resolution for electronic documents, according to some implementations of the current subject matter;

FIG. 3 depicts another example of a process for automatic problem resolution for electronic documents, according to some implementations of the current subject matter;

FIG. 4 depicts another example of a system, according to some implementations of the current subject matter; and

FIG. 5 depicts another example of a system, according to some implementations of the current subject matter.

### DETAILED DESCRIPTION

Electronic documents may be exchanged between systems, such as between an enterprise resource planning system and other external systems. The phrase “enterprise resource planning system” refers to a system used by for example an organization to perform a variety of automated processes for finance (e.g., accounting, financials, and reporting), human resources (e.g., payroll, attendance, and hours worked), manufacturing (e.g., production and inventory), supply chain (e.g., procurement, risk management, and compliance), and/or the like. For example, a document may need to be submitted to an external system associated with a government authority as part of compliance or exchanged between two companies as part of a procurement. The term “document” herein refers to an electronic document, examples of which include any type of document, such as an invoice, a delivery confirmation, and/or the like.

Electronic document processing may include a variety of tasks including identifying the document's storage location, identifying a format for the document exchange (which may depend on document type and system to which the document is being sent), generating the document according to a format (e.g., as required by a destination), sending the document to the correct destination, tracking the sending and/or confirmation of the transmission, and/or other types of processing.

However, electronic document processing may lead to errors, which may in turn require manual intervention by an end-user. These errors may include for example, an incorrect format of the electronic document (which may cause an error during submission or transmission), a rejection of the electronic document by the external system, missing fields (e.g., missing VAT registration or another field in the document), invalid digital certificate, and/or the like. But if the ERP system is handling tens of thousands (if not millions) of documents, even small error rates in the processing may impose a huge burden on the end-user's ERP system including increased resource usage (e.g., memory, storage, network resources, and processing) as corrective actions are taken. To make matters worse, each error may require a different corrective action(s) and use different data sources (e.g., knowledge bases, product documentation, troubleshooting guides, application logs, error logs, and/or the like) to correct the error.

In some embodiments, there is provided an automatic process for resolving one or more errors associated with electronic document processing. In some implementations consistent with the disclosed subject matter, the automatic processing may reduce any back log associated with resolving document processing errors, which saves system resources, such as memory, storage, processor, and/or network resources.

In some embodiments, a machine learning (ML) model may be used to automatically resolve an error with a document. In some embodiments, the ML model may comprise a large language model (LLM), although other types of neural networks may be used as well.

When there is an error to be resolved, the ML model comprising the LLM may receive one or more inputs (also referred to herein as one or more “prompts”). In this example, the LLM may respond to the prompt(s), and the response may be used for a query to a database where knowledge bases, product documentation, troubleshooting guides, application logs, error logs, system configuration information, document formats, and/or the like may be stored. In other words, the LLM may provide (as a response to a prompt) a suggested query. The suggested query may be provided to a query executor to query one or more databases to converge towards a resolution for the “error” associated with the electronic document. In the response to the query, additional information (which is relevant to resolving the “error” associated with the electronic document) may be obtained. This additional information may be used to further prompt the LLM and receive a prompt response. The prompts and queries may be repeated until an “answer” that resolves a cause and/or a resolution for the “error” is found.

As noted, the response (which is from the ML model compromising an LLM) may be a string of text that can be used as a suggested query against one or more databases that may store knowledge bases, product documentation, troubleshooting guides, application logs, system configuration, document formats, error logs, and/or the like. Alternatively, or additionally, the suggested query may be against one or more external systems. For example, the query may retrieve a status of document processing (e.g., where in the document processing, such as identification of the document, retrieval, formatting, transmission, and/or the like did the error occur), configuration data of the system or the document itself, portions of a troubleshooting guide, and/or the like.

Moreover, the ML model (which may comprise an LLM) may provide a resolution to the error. For example, the resolution may include a summary of a previous resolution to the error for the document. Furthermore, the resolution may include a suggestion on how to fix a failed electronic document submission and/or a suggestion on how to deal with a rejected electronic document. The resolution may also include a link to certain capabilities of a system, such as the ERP system, the external system, and/or the like. Alternatively, or additionally, the resolution may be configured in different languages.

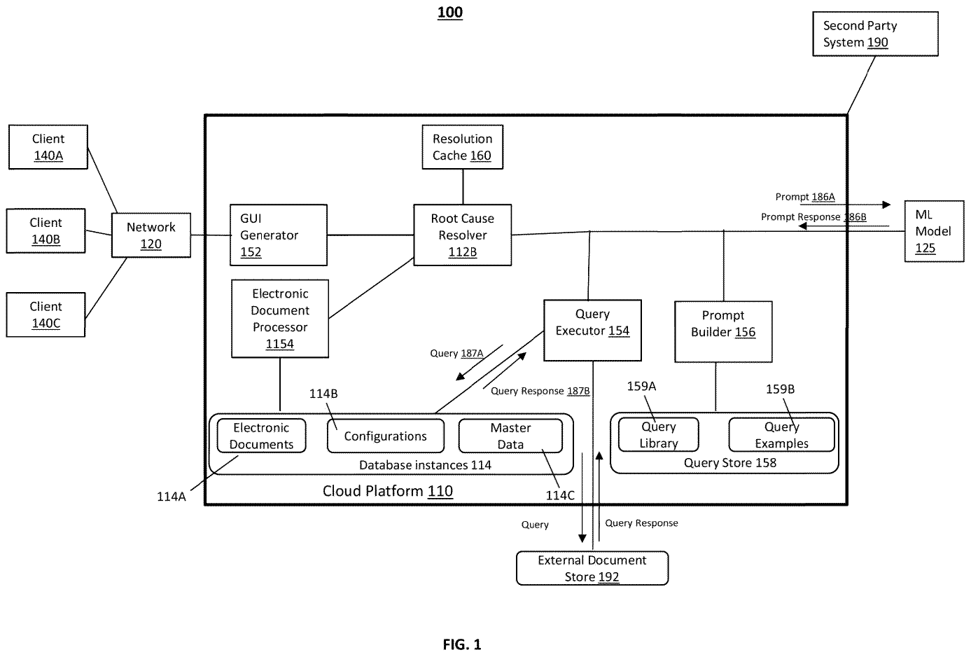

FIG. 1 depicts an example of a system 100 for automatic problem resolution of electronic documents, in accordance with some embodiments. The system may be configured to provide retrieval augmented generation, where information is retrieved (e.g., via queries to one or more databases and/or other source of information) to augment prompts sent to an ML model, such as the ML model 125. The augmented text may be tailored to focus on documents specifically related to root cause analysis for the error as less-relevant text in a prompt to the LLM may lead to so-called hallucination in the LLM and/or increased resource usage (e.g., computational burden, memory, etc.) by the executing LLM.

In some embodiments, the system 100 may include a root cause resolver 112B configured to automatically resolve an error occurring during document processing. The resolution may include identifying the error's cause and/or a way to fix the error. The root cause resolver may be configured as an orchestrator that controls the process for resolving the document processing error.

The system 100 may comprise or be comprised in a cloud platform 110. The cloud platform may provide resources that can be shared among a plurality of tenants. In the example of FIG. 1, the root cause resolver 112B is comprised in the cloud platform 110 as a service or an application. The cloud platform 110 may be configured to provide a variety of services and/or applications including, for example, software-as-a-service (SaaS), platform-as-a-service (PaaS), infrastructure as a service (IaaS), database as a service (DaaS), and/or the like, and these services can be accessed, via a network 120, by one or more tenants of the cloud platform 110. In the example of FIG. 1, the cloud platform 110 may comprise at least a portion of an ERP system.

The network 120 may be any wired and/or wireless network including, for example, a public land mobile network (PLMN), a wide area network (WAN), a local area network (LAN), a virtual local area network (VLAN), the Internet, link(s), a bus, and/or the like.

In the example of FIG. 1, the system 100 may include at least one tenant, such as a first tenant (labeled client device 140A), a second tenant 140B, and a third tenant 140C, although cloud platform 110 may have other quantities of tenants. The clients may each comprise a user device (e.g., a computer including an application such as a browser or other type of application). The user device may be a processor-memory-based device including, for example, a smartphone, a tablet computer, a wearable apparatus, a virtual assistant, an Internet-of-Things (IoT) appliance, and/or the like. Each client may access, via the network 120, at least one of the services at the cloud platform 110. In some implementations, each of the tenants (e.g., client devices 140A-C) represents a separate tenant at the cloud platform 110, such that a tenant's data is not shared with other tenants (absent permission from a tenant). Alternatively, each of the tenants (e.g., client devices 140A-C) may represent a single tenant at the cloud platform 110, such that the tenants can share a portion of the tenant's data, for example. In the example of FIG. 1, a client device may be used to access the root cause resolver to resolve an error with a document being processed by the electronic document processor 1154.

The cloud platform 110 may include resources, such as at least one computer (e.g., a server), at least one data storage, and/or network resources (including network equipment), that couple computer(s) and/or storage. The resources may include services or applications as well. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, SAP Service Cloud, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

Referring again to the cloud platform 110, the cloud platform may include a graphic user interface (GUI) generator 152 that generates (or causes the generation of) user interfaces to be presented at devices, such as client devices 140A-C or the second party system 190.

The cloud platform 110 may also include the electronic document processor 1154. The electronic document processor handles electronic document tasks (e.g., identifying a document, retrieving a document from a database, formatting a document, transmitting/exchanging a document, and/or the like). In the example of FIG. 1, the electronic document processor 1154 is coupled to one or more database instances 114A-C including the database instance 114A where a plurality of electronic documents are stored. The database instance 114B includes configurations, such as a configuration of the cloud platform 110, configuration of the documents (e.g., formats) configurations of other systems, such as second party system 190, and/or the like. The database instance 114C includes master data, such as customer master data, value added tax information, contact information, bank account information, and/or the like.

Moreover, the electronic document processor 1154 may, as noted, orchestrate processing of an electronic document. For example, the electronic document processor may generate electronic documents based on configuration information (which may be stored at for example database instance 114B). The electronic document processor may also submit the document to other systems, such as the second party system 190. Further, the electronic document processor may trigger resolution of an error, and the triggering may be based on system conditions, such as a document's status (e.g., an error status).

In some implementations, the database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premises) and/or another cloud platform. Moreover, although an in-memory database is used in some of the examples, other types of database technologies may be used as well such as NoSQL databases, etc.

As noted, the cloud platform 110 may also include the root cause resolver 112B. The root cause resolver may be comprised as an application (or, e.g., a service) configured to resolve errors that occur during processing of an electronic document. The root cause resolver 112B may be coupled to a resolution cache 160. The resolution cache may include a document error (which was previously resolved and, e.g., mapped to an error resolution for a specific document type) that can be accessed to answer a cause to a document error. If the resolution cache includes an “answer” to the document error, the root cause resolver may bypass the ML model 125 based resolution for the error.

The cloud platform 110 may also include a query executor 154. The query executor executes queries against for example one or more databases, such as database instances 114A-C as well as other types of data stores, such as external document store 192 which may comprise a server, a website, a database, a NoSQL database, and/or the like. The external data store may include information that can be used to augment the prompts to the ML model during document error resolution.

The cloud platform 110 may also include a prompt builder 156. For example, the prompt builder is configured to build the requests, such as the prompts, sent towards the ML model 125, such as an LLM.

The cloud platform 110 may also include a query store 158. For example, the query store may include a query library 159A. The query library includes queries that may be accessed and executed to receive new observations (which can be used to augment prompts toward the ML model 125). A sample item in the query store may be be the query “/xml/{electronicDocumentId},” for example. The query library may further include query examples 159B that indicates how specific, valid queries should look like (e.g., query structure or formats). A query example for the query “/xml/{electronicDocumentId}” may be “/xml/4B73D2576A291EDFAAFF704E2B9DCC9F,” for example. The query library 159A may include a plurality of queries to make the error-resolution process extensible. The prompt builder may for example choose, based on parameters such as system configuration, document status, and/or the like, a query from the query library 159A. For example, the prompt builder may choose to include the query “/xml/{electronicDocumentId}” as well as a corresponding example such as “/xml/4B73D2576A291EDFAAFF704E2B9DCC9F” as queries toward the database instances, for example.

The cloud platform 110 may also couple to the ML model 125. In some embodiments, the ML model comprises a large language model (LLM). Although some of the examples refer to an LLM, other types of ML models, such as neural networks, deep neural networks, generative machine learning, generative artificial intelligence, and/or natural language processing may be used as well. Moreover, although the ML model 125 is depicted as external to the cloud platform 110, the ML model may be at least in part comprised in a cloud platform, such as cloud platform 110.

The cloud platform 110 may also couple to one or more other systems, such as the second party system 190. For example, the second party system may be associated with for example a receiver of the electronic document. In some instances, the error in the electronic document may be detected by the receiver of the electronic document. For example, when the electronic document processor 1154 sends a document to the second party system, the second party system may respond with an indication of an error.

In operation for example, the client device 140A (e.g., an end-user of the client device) may interact with a user interface (which is caused to be presented and/or generated by the GUI generator 152) to send a request to resolve an error associated with an electronic document stored at the database instance 114A. The resolution may be triggered when there is an error in the electronic documents processing. To illustrate, the second party system 190 may be associated with a financial institution, tax authority, customer, etc., and the second party system may reject an electronic document provided by the cloud platform 110. The rejection may indicate an error in the electronic document, indicate merely a rejection of the electronic document, and/or may include a reason for the rejection (or, e.g., description of the error). The error may thus need one or more actions to resolve the error, so the root cause resolver 112B may be used to determine the one or more actions to resolve the error in the electronic document. For example, an error in handling of an electronic document may be presented at a user interface at the client device 140A, in which case the client device 140A (e.g., the end-user) may request the root cause resolver 112B to resolve the document processing error (e.g., via a selection or a request for resolving the error, although the error may automatically be provided to the root cause resolver 112B for resolution). The resolution request may include the identity of the electronic document and (if available) other information related to the error, and the request may be provided, as noted, to the root cause resolver 112B to initiate resolution of the error.

The root cause resolver 112B may interact with the prompt builder 156 to create “input” text strings (e.g., a prompt). The prompt may be used as an input to the ML model 125, which as noted may comprise an LLM.

The prompt response from the ML model 125 (which may comprise for example an LLM) may be used by the query executor 154 to retrieve information that may be used to augment additional prompts toward the ML model as part of the error resolution process. The prompt to the ML model 125 and the query executor's 154 query may be repeated until an answer that resolves the error is identified. In some implementations, the answer that resolves the error may be stored, as noted, in for example the resolution cache 160. The resolution cache may store one or more errors linked to one or more prior resolutions for documents. As such, the root cause resolver 112B may access a cached answer that resolves a document processing error and thus by-pass the prompt builder 156 and ML model 125.

The query executor 154 may receive (as an input) the output (e.g., responses to prompts) provided by the ML model 125 comprising an LLM, for example. The query executor may parse the prompt response's text string(s) to determine a query for execution (and/or which parameters to provide with the query). The parameters may be dependent on a specific query and may have to be described and declared in a query directory, for example. The prompt response (from the ML model) may be as follows: “/xml/4B73D2576A291EDFAAFF704E2B9DCC9F,” for example. When this is the case, the query executor may parse the prompt response and may search (e.g., in the query library 159A and/or query examples 159B) for a semantically similar match. In this example, the query executor may identify as a match the following query: “/xml/{electronicDocumentId}” which is parametrized by “electronicDocumentId”. The matching may be performed using regular expressions. For example, the regular expression “\{\s*([\hat{ }\]*)\s*\}” would match the response prompt “/xml/4B73D2576A291EDFAAFF704E2B9DCC9F” to the query “/xml/{electronicDocumentId}”. The query executor 154 may send the query towards the database instances 114 and/or the external document store 192 to retrieve data that can be used to augment subsequent prompts sent toward the ML model 125 and thus to converge more quickly to an answer resolving the document error. In the example above, the query executor sends a query to the database instances to search for the XML content of the electronic document with the ID “4B73D2576A291EDFAAFF704E2B9DCC9F”.

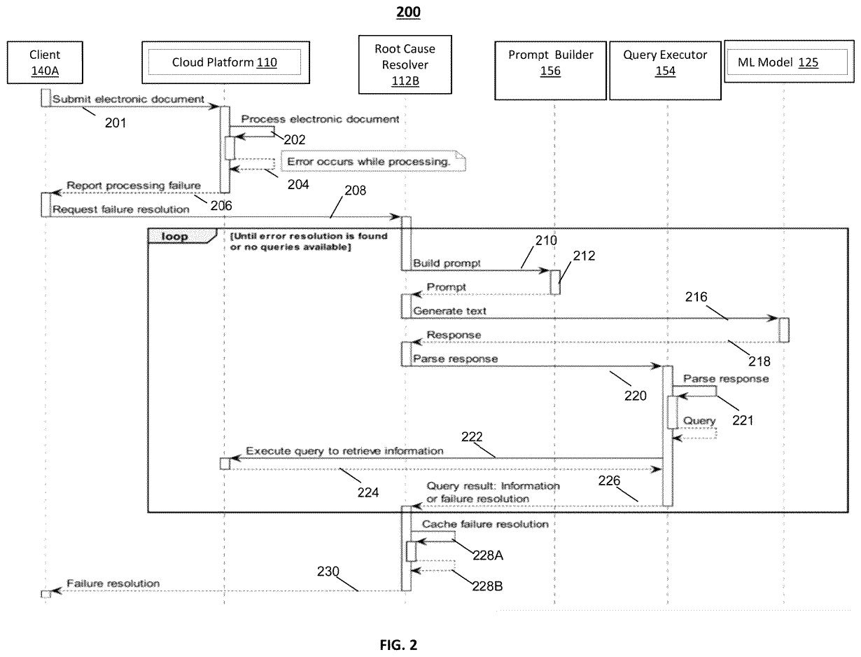

FIG. 2 depicts an example of a process 200 for automatic error resolution, in accordance with some embodiments.

At 201, an electronic document may be provided to an electronic document processor 1154 for processing at 202. This processing may formatting the electronic document, sending the electronic document to a destination, and/or the like. During processing, an error may occur at 202, which is then flagged or indicated by sending the error towards the client device 140A via the electronic document processor (204-206).

At 208, the client device 140A may send a request towards the root cause resolver 112B. This request may include an identity of the document that caused the error, information associated with the error (e.g., error description, time of error, status of cloud platform, identity of destination, and/or other information), and/or other information that can assist in resolving the error.

At 210, the root cause resolver 112B instructs the prompt builder 156 to build a prompt for the ML model 125. The prompt builder may then build the prompt(s) at 212 and return the prompt(s) to the root cause resolver 112B. At 216, the root cause resolver 112B sends the prompt(s) toward the ML model 125, which as noted may comprise an LLM. The ML model may, based on the prompt(s) and using natural language processing, respond to the prompts with a prompt response 218. The prompt response may be parsed and then sent at 220 to the query executor 154. The query executor queries, at 222, the cloud platform's 110 database instances 114A-C and/or external document store 192; a query response 224 is provided to the query executor. This query response 224 is provided to the root cause resolver 112B, which repeats the process 210-226 until the ML Model 125 indicates an end of query (e.g., EOQ) or answer has been reached. The final query response (after one or more repeats or iterations of 210-226) may be cached at the resolution cache 160 and forwarded at 230 to the client device 140A as an indication of the resolution to the error in document processing.

The approach may include different applications of caching. For example, whenever a problem is resolved, the resolution may be cached at the resolution cache 160. When this is the case, caching is used to make sure that existing error resolutions can be presented faster to the user at for example client device 140A when the user requests a same or similar error resolution again for the same or similar electronic document. Additionally, the same or similar error resolution can be presented to at the client device 140A (e.g., via GUI generator 152) for semantically similar as well as the same types of error resolutions.

Moreover, whenever a query is sent by the query executor 154, the query results may be cached (e.g., at resolution cache 160 or another cache at the cloud platform 110). This caching is used ensure the ML model 125 (which comprises the LLM) gets a hint when certain queries are generated for example twice or more times within the same problem resolution cycle. The ML model/LLM should get feedback that it is going in circles so to speak (e.g., “Your Query has been executed before and the Output has been shared already. Revise your Query”).

With respect to the prompt builder 156 and its prompts (or inputs) to the ML model 125, the prompts may provide context for natural language processing by the ML model 125. For example, the prompt may include (1) context, (2) a task description, (3) available queries, (4) examples, (5) performed queries and their results, and/or (6) an initial question. Examples of these aspects of the prompt are further described as follows.

The prompt's context may include an explanation of electronic documents. For example, the prompt may contain: “The context of the following is the processing of electronic documents. Electronic documents may include invoices or delivery notes. For example, electronic documents might need to be a) prepared in a business information system, b) submitted to tax authorities or c) exchanged between customers and suppliers.” For example, the prompt may include the generated XML document, raw source document data (e.g., in a CSV format), the error message (which was generated during XML generation), or validation responses from external services.

The prompt's task description may include a description of the approach, such as different queries which are available, queries that should not be repeated, one query may be suggested by the ML model per iteration, and/or if an answer is found by the ML model 125, no more queries should be proposed, and an answer should be provided. The “approach” refers to a plan or strategy for iteratively resolving the problem. However, a goal of the approach is to not state explicitly how the problem should be solved but the system provides the queries to solve the problem. The ML component (e.g. the LLM) is iteratively called and effectively allowed to use certain queries as it wants. The prompt's available queries may include a list of the available queries and a description of the expected result. The prompt's examples may include one or more examples of queries and their results. The examples may provide to the ML model 125 a format of the expected answer (which may be referred to as “few-shot prompting”). The prompt's performed queries and their results may be used (or added to a prompt) when at least one query was suggested and executed. The prompt's initial question may be used to guide the ML model's answer towards an initial direction. For example, “An error was detected for electronic document identifier=1111. What was the root cause?”

With respect to available queries (e.g., “/xml/{electronicDocumentId}” which may be stored in the query library 159A), the usefulness of the ML model's 125 approach towards a resolution (e.g., an answer) may depend on which queries are available. Examples of the available queries are depicted at Table 1. These available queries are stored in the query library 159A. For each query, one or more examples can be stored to help the ML model 125 (e.g., LLM) understand how the query may be used. Depending on the exact error being solved, the system may decide to make only a subset of queries “available”. Here, “available” means whether they are contained at the top of the prompt. For example, during error resolution for a given electronic document: The query “/xml/{electronicDocumentId}” would not be “available” if there is no XML content for the electronic document in the database instance 114A. There may be a variety of factors that may make it difficult to find a resolution in electronic document processing. For example, a factor may be related to different countries having different processes and languages for submitting electronic documents. When this is the case, the input for the queries may be generalized so that the inputs are independent of country. But the corresponding query results of the queries may be specific to a country. For example, the format of the representation of an electronic document may be unique to a given country or region.

For resolving errors during electronic document processing, queries, such as the example listed in Table 1, may be used against database instances 114, external document store 192, and/or the like to obtain additional information to augment prompts. Table 1 is merely an example as other available queries may be used as well.

TABLE 1
Query 1: Retrieve a representation of the electronic document. The
representation may be used for submitting the document to for example a tax
authority or for exchanging the document with customers, suppliers, and/or the
like. A sample format of the representation may be “Extensible Markup
Language” (XML) or “JavaScript Object Notation” (JSON). The representation
is the payload used for communicating the electronic document to other
business information systems.
Query 2: Retrieve information from a knowledge base using keywords. For
example, keywords may include “expired certificate” and the knowledge base
might return instructions on how to renew expired certificates. For example,
this query may be useful if the approach has found an error message in previous
queries.
Query 3: Retrieve master data of the parties participating in the business
process. Master data may include information such as name, location, or VAT
registration number. Master data (see, e.g., database instance 114C) may be
used during root cause resolution. For example, the VAT registration number
may be missing in the representation (query 1). Querying master data may
allow the resolution process to identify and correct the error.
Query 4: Retrieve a source document of the electronic document. The source
document may be created by the cloud platform 110.
Query 5: Retrieve customer specific configuration related to electronic
document creation. For example, electronic documents may be created based on
configured source document types. The source document types may include an
invoice, a delivery note, etc.
Query 6: Retrieve customer specific configuration related to mapping of
terminology. For example, the configuration may include a mapping of internal
terms of the cloud platform 110 to standardized terms used by other systems,
such as external second party system 190. Examples of the terms may include
units of measure, tax codes, payment methods, etc.
Query 7: Retrieve customer specific configuration related to system integration.
For example, the cloud platform 110 may be connected to the external second
party system 190, such as a system associated with a tax authority.
Query 8: Retrieve the history of the electronic document. The history may
include previous steps performed for the submission of the electronic document.
Examples of previous steps include: information associated with the creation of
the electronic document and/or information exchanged between buyer and
supplier.

The following provides examples of resolution scenarios that converge to a final answer to resolve the document processing error. Each of the following examples corresponds to an automated root cause resolution for a given error. In each example, there may be a plurality of iterations of prompts to the ML model 125 (e.g., LLM) and corresponding queries to obtain information to augment the prompts. Each prompt and query execution may correspond to an iteration. In the examples below, the text “[EOQ]” is used to denote “end of query” and is used to determine or indicate that an answer has been found. In the following example resolution scenario, a certificate, such as a digital certificate, for an electronic document is expired. This expired certificate causes an error in document processing, which is resolved by the root cause resolver 112B.

The first request (e.g., prompt 186A) sent by prompt builder 156 to the ML model 125 (comprising an LLM) may be as follows:

You may perform Thoughts and Queries for a task:
Thoughts can reason about the current situation.
Queries allow you to retrieve information.
If you have found the answer, stop further queries with “[EOQ]” and provide an answer.
Available Queries: (1) Query: /xml/{eDocumentid} −> Returns the XML content of a document and
(2) Query: /troubleshooting/{keyword} −> Returns a troubleshooting guide for a keyword {Few-shot
prompting to give examples of query results}
Task: What went wrong with eDocument ‘myId’?

For the first request (e.g., prompt 186A), the ML model 125 (comprising the LLM) may provide a first prompt response (e.g., prompt response 186B) as follows:
Thought 1: I should retrieve the contents of the eDocument ‘myld’. Query 1: /xml/myld

The first prompt response may be used for a first query execution (e.g., query 187A), by the query executor 154. For example, the query executor may parse and execute the suggested query “/xml/myId”. The result of this query may be a query response (e.g., query response 187B) as follows:
<xml>Certificate “myCertificate” has expired.</xml>

When the first prompt response, the first query, and the first query response are combined, the prompt builder 156 may generate a second prompt. This second prompt may be sent to the ML model 125 (which comprises the LLM and may be as follows:

{Request 1}
Thought 1: I should retrieve the contents of the eDocument ‘myId’.
Query 1: /xml/myId
Observation 1: <xml>Certificate “myCertificate” has expired.</xml>

The ML model 125 (comprising the LLM) may provide a second prompt response to this prompt as follow:

Thought 2: I should check the troubleshooting guide for how to resolve expired certificates.
Query 2: /troubleshooting/certificates

The second query execution may include the query executor 154 parsing and executing the proposed troubleshooting query “/troubleshooting/certificates” toward the database instances 114 and/or the external document store 192. This information may be retrieved from for example a source of information, such as the external document store 192 (or other store), to obtain knowledge. The second query result of the query execution may be as follows:
Troubleshooting guide: Use command ‘ . . . ’ to check for expired certificates.

Again, the second prompt response and second query response may be combined to form a third request as follows:

{Request 2} Thought 2: I should check the troubleshooting guide for how to resolve expired
certificates.
Query 2: /troubleshooting/certificates
Observation 2: “Troubleshooting guide: Use command ‘...’ to check for expired certificates.”

In response to this combined query, the ML model 125 (comprising the LLM) may respond with the following prompt response as follows:
[EOQ] Please use command ‘ . . . ’ to check whether certificate ‘myCertificate’ has expired.

When the [EOQ] is received for example, the cloud platform 110 may provide to the client device 140A an indication of the resolution of the error, which may include a cause and/or one or more suggestions for solving the error or its cause. For example, the GUI generator may cause to be presented on a user interface at client device 140A the following: Please use command ‘ . . . ’ to check whether certificate ‘myCertificate’ has expired.

Table 2 below provides another example scenario for which an electronic document is missing data or information. In the example of Table 3, the iterations of request (e.g., LLM prompt) and query result in the answer “[EOQ] Please maintain VAT number in master data.” As such, the cloud platform 110 may provide to the client device 140A an indication of the resolution of the error. For example, the GUI generator may cause to be presented on a user interface at client device 140A the following: Please maintain VAT number in master data at database instance 114C.

```
TABLE 2
    Request 1 to LLM:
      You may perform Thoughts and Queries for a task:
      Thoughts can reason about the current situation.
      Queries allow you to retrieve information.
      If you have found the answer, stop further queries with “[EOQ]” and provide an answer.
      Available Queries:
              Query: /xml/{eDocumentId]
              −> Returns the XML content of a document
              Query: /xml/error/{eDocumentId]
              −> Returns the error of a document
              Query: /troubleshooting/{keyword]
              −> Returns a troubleshooting guide for a keyword
              Query: /masterdata/businesspartner/{businesspartnerId] −> Returns the business partner
              content of a certain business partner
      {Few-shot prompting to give examples of query results]
      Task: What went wrong with eDocument ‘myId’?
    Response 1 from LLM:
              Thought 1: I should retrieve the error of eDocument ‘myId’.
              Query 1: /xml/error/myId
    Query execution 1: The business information system parses and executes the suggested query
    “xml/error/myId”. The result of the query is:
              <xml>VAT Registration Number is empty</xml>
    We then combine request 1, response 1 and query 1 to create request 2.
    Response 1 from LLM:
              Thought 1: I should retrieve the error of eDocument ‘myId’.
              Query 1: /xml/error/myId
    Query execution 1: The business information system parses and executes the suggested query
    “xml/error/myId”. The result of the query is:
              <xml>VAT Registration Number is empty</xml>
    We then combine request 1, response 1 and query 1 to create request 2.
    Request 2 to LLM:
              {Request 1]
              Thought 1: I should retrieve the error of eDocument ‘myId’.
              Query 1: /xml/error/myId
            Observation 1: <xml>VAT Registration Number is empty</xml>
    Response 2 from LLM:
          Thought 2: I should retrieve the contents of the eDocument for more
          context.
          Query 2: /xml/myId
Query execution 2: The business information system parses and executes the suggested query “xml/myId”.
The result of the query is:
        <xml>...<VAT Registration Number> </VAT Registration Number> ...</xml>
  We then combine request 2, response 2 and query 2 to create request 3.
Request 3 to LLM:
          {Request 2}
          Thought 2: I should retrieve the contents of the eDocument for more
          context.
          Query 2: /xml/myId
          Observation 2: <xml>... <VAT Registration Number> </VAT
          Registration Number> ...</xml>
Response 3 from LLM:
          Thought 3: The eDocument seems to have an empty VAT registration
          number. I should check master data whether a VAT registration number
          exists.
          Query 3: /masterdata/businesspartner/myBusinesspartnerId
Query execution 3: The business information system parses and executes the suggested query
“/masterdata/businesspartner/myBusinesspartnerId”. The result of the query is:
          Error: Business Partner's VAT Registration Number is empty
  We then combine request 3, response 3 and query 3 to create request 4.
Request 4 to LLM:
          {Request 3}
          Thought 3: The eDocument seems to have an empty VAT registration
          number. I should check master data whether a VAT registration number
          exists.
          Query 3: /masterdata/businesspartner/myBusinesspartnerId
          Observation 3: Business Partner's VAT Registration Number is empty
Response 4 from LLM:
          [EOQ] Please maintain VAT number in master data.
```

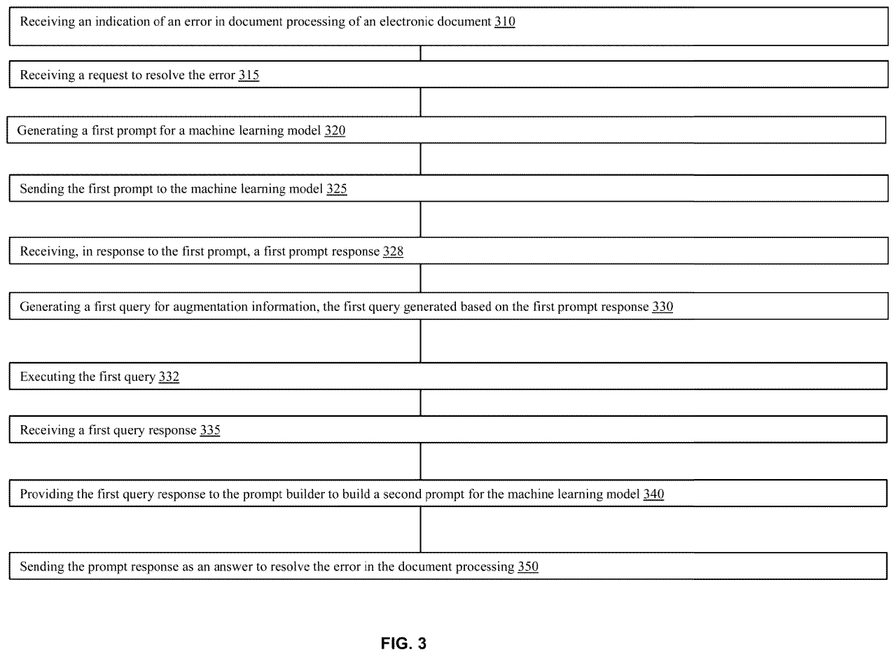

FIG. 3 depicts an example of a process 300 for automatic error resolution for documents, in accordance with some embodiments.

At 310, the process may include “receiving an indication of an error in document processing of an electronic document,” in accordance with some embodiments. For example, the electronic document processor 1154 may detect an error in document processing (e.g., at 202-204 of FIG. 2).

At 315, the process may include “in response to the indication of the error, receiving a request to resolve the error,” in accordance with some embodiments. For example, a request may be received by the root cause resolver 112B (see, e.g., 208 at FIG. 2). To illustrate further, a user interface (which may be presented at the client device 140A and generated by the GUI generator 152) may indicate the error (e.g., document identifier, document, and error). In this example, a selection at the user interface may trigger a message including the indication to the root cause resolver to resolve the document processing error.

At 320, the process may include generating, by a prompt builder, a first prompt for a machine learning model,” in accordance with some embodiments. For example, the prompt builder may build a first prompt to the ML model 125. For example, the first prompt may include, as noted, 1) context, (2) a task description, (3) available queries, (4) examples, (5) performed queries and their results, and/or (6) an initial question.

At 325, the process may include sending the first prompt to the machine learning model, in accordance with some embodiments. In some implementations, the prompt builder 156 builds a prompt and provides it to the root cause resolver 112B that sends the prompt 186A to the ML model 125 (see, e.g., 212-216 at FIG. 2).

At 328, the process may include receiving, in response to the first prompt, a first prompt response,” in accordance with some embodiments. For example, the ML model 125 may respond to the first prompt, and this first prompt response 186B may be provided to the root cause resolver 112B (see, e.g., 218 at FIG. 2).

At 330, the process may include in response to receiving a first prompt response, generating a first query for augmentation information, the first query generated based on the first prompt response,” in accordance with some embodiments. For example, the root cause resolver may provide the first prompt response to a query executor which may parse the response (see, e.g., FIG. 2 at 220-221). Moreover, the query executor may access the query store 158 to check for the same or similar query examples, for example.

At 332, the process may include executing the first query,” in accordance with some embodiments. For example, the query executor 154 may execute the query 187A towards for example a database instance (e.g., database instances 114) or an external store of knowledge (see, e.g., FIG. 2 at 222).

At 335, the process may include receiving, in response to the first query, a first query response,” in accordance with some embodiments. For example, the query executor 154 may receive a query response 187B (see, e.g., FIG. 2 at 224).

At 340, the process may include in response to receiving the first query response to the first query, providing the first query response to the prompt builder to build a second prompt for the machine learning model,” in accordance with some embodiments. For example, the query executor 154 may provide the query response to the root cause resolver 112B so that it can build (if needed) another prompt (see, e.g., FIG. 2 at 226 and 212). In some embodiments the prompt builder may combine the first prompt response, the first query, and the first query response to form the second prompt.

At 350, the process may include in response to the second prompt response indicating end of question, sending the prompt response as an answer to resolve the error in the document processing. For example, when the prompt response from the ML model indicates a final answer (e.g., EOQ), the root cause resolver 112B may send an indication (e.g., the resolution to the error) to the client device 140A (see, e.g., FIG. 2 at 230). If the second prompt response does not include the EOQ, the process may include repeating the query, query response, and prompt (see, e.g., 210-226) until the ML model responds with an EOQ (which indicates end of query or an answer has been found).

Moreover, the root cause resolver 112B may cache at 228A and 228B (e.g., store in the resolution cache 160) the error resolution so that it can be retrieved to find resolution to other errors in the same or similar document types.

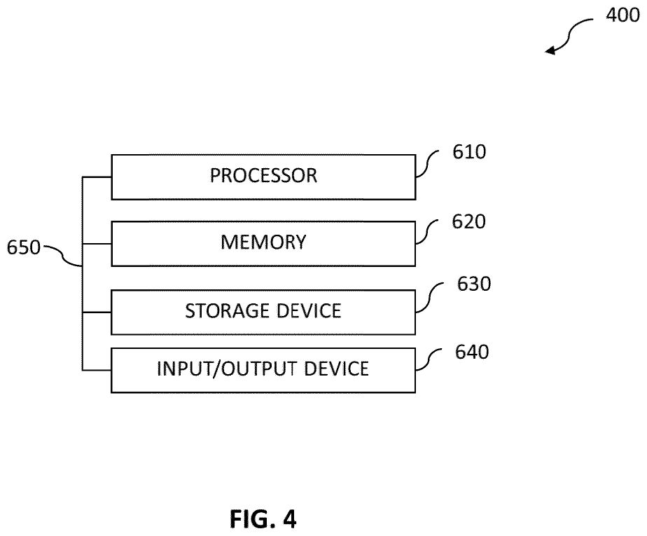

In some implementations, the current subject matter may be configured to be implemented in a system 400, as shown in FIG. 4. The system 400 may include a processor 610, a memory 620, a storage device 630, and an input/output device 640. Each of these components may be interconnected using a system bus 650. The processor 610 may be configured to process instructions for execution within the system 400. In some implementations, the processor 610 may be a single-threaded processor. In alternate implementations, the processor 610 may be a multi-threaded processor. The processor 610 may be further configured to process instructions stored in the memory 620 or on the storage device 630, including receiving or sending information through the input/output device 640. The processor 610 may be further configured to execute the processes described with reference to FIGS. 2 and/or 3, for example. The memory 620 may store information within the system 400. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 400. In some implementations, the storage device 630 may be a computer-readable medium. In alternate implementations, the storage device 630 may be a floppy disk device, a hard disk device, an optical disk device, a tape device, non-volatile solid state memory, or any other type of storage device. The input/output device 1640 may be configured to provide input/output operations for the system 400. In some implementations, the input/output device 640 may include a keyboard and/or pointing device. In alternate implementations, the input/output device 1640 may include a display unit for displaying graphical user interfaces.

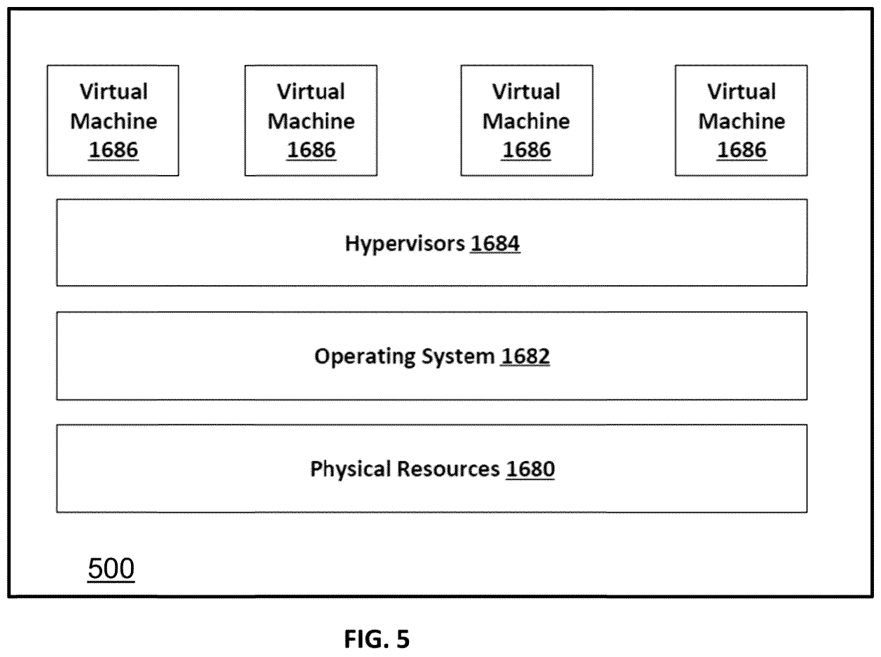

FIG. 5 depicts an example implementation of the system 500. The system 500 may comprise one or more of the components of FIG. 1, for example. For example, the in-memory database, applications, persistent storage, and/or the like may be implemented using the virtual machines to provide a cloud-based implementation. The system 500 may be implemented using various physical resources 1680, such as at least one or more hardware servers, at least one storage, at least one memory, at least one network interface, and the like. The system may also be implemented using infrastructure, as noted above, which may include at least one operating system 1682 for the physical resources 1680 and at least one hypervisor 1684 (which may create and run at least one virtual machine 1686). For example, each multitenant application may be run on a corresponding virtual machine 1686.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising:
receiving an indication of an error in document processing of an electronic document;
in response to the indication of the error, receiving a request to resolve the error;
generating, by a prompt builder, a first prompt for a machine learning model;
sending the first prompt to the machine learning model;
receiving, in response to the first prompt, a first prompt response;
in response to receiving a first prompt response, generating a first query for augmentation information, the first query generated based on the first prompt response;
executing the first query;
receiving, in response to the first query, a first query response;
in response to receiving the first query response to the first query, providing the first query response to the prompt builder to build a second prompt for the machine learning model; and
in response to the second prompt response indicating end of question, sending the prompt response as an answer to resolve the error in the document processing.

Example 2: The computer-implemented method of Example 1, wherein the prompt builder builds the second prompt by combining the first prompt response, the first query, and the first query response.

Example 3: The computer-implemented method of any of Examples 1-2, wherein in response to the second prompt response not indicating the end of question, sending the second prompt response to a query builder to generate a second query based on the second prompt response; and
executing the second query.

Example 4: The computer-implemented method of any of Examples 1-3, further comprising:
receiving, in response to the second query, a second query response; and
in response to receiving the second query response to the first query, providing the second query response to the prompt builder to build a third prompt for the machine learning model.

Example 5: The computer-implemented method of any of Examples 1-4, wherein the prompt builder builds the third prompt by combining the second prompt response, the second query, and the second query response.

Example 6: The computer-implemented method of any of Examples 1-5, wherein in response to the third prompt response indicating end of question, sending the third prompt response as the answer to resolve the error in the document processing; and
in response to the third prompt response not indicating the end of question, sending the third prompt response to the query builder to generate a fourth query based on the third prompt response.

Example 7: A system comprising:
at least one processor; and
at least one memory including instructions, which when executed by the at least one processor causes operations comprising:
   receiving an indication of an error in document processing of an electronic document;
   in response to the indication of the error, receiving a request to resolve the error;
   generating, by a prompt builder, a first prompt for a machine learning model;
   sending the first prompt to the machine learning model;
   receiving, in response to the first prompt, a first prompt response;
   in response to receiving a first prompt response, generating a first query for augmentation information, the first query generated based on the first prompt response;
   executing the first query;
   receiving, in response to the first query, a first query response;
   in response to receiving the first query response to the first query, providing the first query response to the prompt builder to build a second prompt for the machine learning model; and
   in response to the second prompt response indicating end of question, sending the prompt response as an answer to resolve the error in the document processing.

Example 8: The system of Example 7, wherein the prompt builder builds the second prompt by combining the first prompt response, the first query, and the first query response.

Example 9: The system of any of Examples 7-8, wherein in response to the second prompt response not indicating the end of question, sending the second prompt response to a query builder to generate a second query based on the second prompt response; and
executing the second query.

Example 10: The system of any of Examples 7-9, further comprising:
receiving, in response to the second query, a second query response; and
in response to receiving the second query response to the first query, providing the second query response to the prompt builder to build a third prompt for the machine learning model.

Example 11: The system of any of Examples 7-10, wherein the prompt builder builds the third prompt by combining the second prompt response, the second query, and the second query response.

Example 12: The system of any of Examples 7-11, wherein in response to the third prompt response indicating end of question, sending the third prompt response as the answer to resolve the error in the document processing; and
in response to the third prompt response not indicating the end of question, sending the third prompt response to the query builder to generate a fourth query based on the third prompt response.

Example 13: A non-transitory computer-readable storage medium including instructions, which when executed by at least one processor causes operations comprising:
receiving an indication of an error in document processing of an electronic document;
in response to the indication of the error, receiving a request to resolve the error;
generating, by a prompt builder, a first prompt for a machine learning model;
sending the first prompt to the machine learning model;
receiving, in response to the first prompt, a first prompt response;
in response to receiving a first prompt response, generating a first query for augmentation information, the first query generated based on the first prompt response;
executing the first query;
receiving, in response to the first query, a first query response;
in response to receiving the first query response to the first query, providing the first query response to the prompt builder to build a second prompt for the machine learning model; and
in response to the second prompt response indicating end of question, sending the prompt response as an answer to resolve the error in the document processing.

Example 14: The non-transitory computer-readable storage medium of Example 13, wherein the prompt builder builds the second prompt by combining the first prompt response, the first query, and the first query response.

Example 15: The non-transitory computer-readable storage medium of any of Examples 13-14, wherein in response to the second prompt response not indicating the end of question, sending the second prompt response to a query builder to generate a second query based on the second prompt response; and
executing the second query.

Example 16: The non-transitory computer-readable storage medium of any of Examples 13-15, further comprising:
receiving, in response to the second query, a second query response; and
in response to receiving the second query response to the first query, providing the second query response to the prompt builder to build a third prompt for the machine learning model.

Example 17: The non-transitory computer-readable storage medium stem of any of Examples 13-16, wherein the prompt builder builds the third prompt by combining the second prompt response, the second query, and the second query response.

Example 18: The non-transitory computer-readable storage medium of any of Examples 13-17, wherein in response to the third prompt response indicating end of question, sending the third prompt response as the answer to resolve the error in the document processing; and
in response to the third prompt response not indicating the end of question, sending the third prompt response to the query builder to generate a fourth query based on the third prompt response.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
receiving an indication of an error in document processing of an electronic document;
in response to the indication of the error, receiving a request to resolve the error;
generating, by a prompt builder, a first prompt for a machine learning model;
sending the first prompt to the machine learning model;
receiving, in response to the first prompt, a first prompt response;
in response to receiving a first prompt response, generating a first query for augmentation information, the first query generated based on the first prompt response;
executing the first query;
receiving, in response to the first query, a first query response;
in response to receiving the first query response to the first query, providing the first query response to the prompt builder to build a second prompt for the machine learning model; and
in response to the second prompt response indicating end of question, sending the prompt response as an answer to resolve the error in the document processing.

2. The computer-implemented method of claim 1, wherein the prompt builder builds the second prompt by combining the first prompt response, the first query, and the first query response.

3. The computer-implemented method of claim 1, wherein in response to the second prompt response not indicating the end of question, sending the second prompt response to a query builder to generate a second query based on the second prompt response; and
executing the second query.

4. The computer-implemented method of claim 3, further comprising:
receiving, in response to the second query, a second query response; and
in response to receiving the second query response to the first query, providing the second query response to the prompt builder to build a third prompt for the machine learning model.

5. The computer-implemented method of claim 4, wherein the prompt builder builds the third prompt by combining the second prompt response, the second query, and the second query response.

6. The computer-implemented method of claim 5, wherein in response to the third prompt response indicating end of question, sending the third prompt response as the answer to resolve the error in the document processing; and
in response to the third prompt response not indicating the end of question, sending the third prompt response to the query builder to generate a fourth query based on the third prompt response.

7. A system comprising:
at least one processor; and
at least one memory including instructions, which when executed by the at least one processor causes operations comprising:
receiving an indication of an error in document processing of an electronic document;
in response to the indication of the error, receiving a request to resolve the error;
generating, by a prompt builder, a first prompt for a machine learning model;
sending the first prompt to the machine learning model;
receiving, in response to the first prompt, a first prompt response;
in response to receiving a first prompt response, generating a first query for augmentation information, the first query generated based on the first prompt response;
executing the first query;
receiving, in response to the first query, a first query response;
in response to receiving the first query response to the first query, providing the first query response to the prompt builder to build a second prompt for the machine learning model; and
in response to the second prompt response indicating end of question, sending the prompt response as an answer to resolve the error in the document processing.

8. The system of claim 7, wherein the prompt builder builds the second prompt by combining the first prompt response, the first query, and the first query response.

9. The system of claim 7, wherein in response to the second prompt response not indicating the end of question, sending the second prompt response to a query builder to generate a second query based on the second prompt response; and
executing the second query.

10. The system of claim 9, further comprising:
receiving, in response to the second query, a second query response; and
in response to receiving the second query response to the first query, providing the second query response to the prompt builder to build a third prompt for the machine learning model.

11. The system of claim 10, wherein the prompt builder builds the third prompt by combining the second prompt response, the second query, and the second query response.

12. The system of claim 11, wherein in response to the third prompt response indicating end of question, sending the third prompt response as the answer to resolve the error in the document processing; and
in response to the third prompt response not indicating the end of question, sending the third prompt response to the query builder to generate a fourth query based on the third prompt response.

13. A non-transitory computer-readable storage medium including instructions, which when executed by at least one processor causes operations comprising:
receiving an indication of an error in document processing of an electronic document;
in response to the indication of the error, receiving a request to resolve the error;
generating, by a prompt builder, a first prompt for a machine learning model;
sending the first prompt to the machine learning model;
receiving, in response to the first prompt, a first prompt response;
in response to receiving a first prompt response, generating a first query for augmentation information, the first query generated based on the first prompt response;
executing the first query;
receiving, in response to the first query, a first query response;
in response to receiving the first query response to the first query, providing the first query response to the prompt builder to build a second prompt for the machine learning model; and
in response to the second prompt response indicating end of question, sending the prompt response as an answer to resolve the error in the document processing.

14. The non-transitory computer-readable storage medium of claim 13, wherein the prompt builder builds the second prompt by combining the first prompt response, the first query, and the first query response.

15. The non-transitory computer-readable storage medium of claim 13, wherein in response to the second prompt response not indicating the end of question, sending the second prompt response to a query builder to generate a second query based on the second prompt response; and
executing the second query.

16. The non-transitory computer-readable storage medium of claim 15, further comprising:
receiving, in response to the second query, a second query response; and
in response to receiving the second query response to the first query, providing the second query response to the prompt builder to build a third prompt for the machine learning model.

17. The non-transitory computer-readable storage medium of claim 16, wherein the prompt builder builds the third prompt by combining the second prompt response, the second query, and the second query response.

18. The non-transitory computer-readable storage medium of claim 17, wherein in response to the third prompt response indicating end of question, sending the third prompt response as the answer to resolve the error in the document processing; and
in response to the third prompt response not indicating the end of question, sending the third prompt response to the query builder to generate a fourth query based on the third prompt response.
